(19) United States
(12) Patent Application Publication
(10) Pub. No.: US 2002/0131674 A1
(43) Pub. Date: Sep. 19, 2002

(54) Optical wavelength encoded multiple access arrangement

(75) Inventor: Henry Hung, Paradise Valley, AZ (US)

Correspondence Address: Donald J. Lenkszus, DONALD J. LENKSZUS, P.C., P.O. BOX 3064, CAREFREE, AZ, 85377, US

(73) Assignee: MICRO PHOTONIX INTEGRATION CORPORATION

(21) Appl. No.: 09/811,303

(22) Filed: Mar. 17, 2001

(51) Int. Cl. G02B 6/35; G02B 6/26

(52) U.S. Cl. 385/16; 385/15

(57) ABSTRACT

An optical wavelength multiple access system includes a laser source providing multiple wavelength component optical signals. The optical signals are coupled to a rapid switched narrow line filter. The rapid switched narrow line filter is controllable to output selected predetermined wavelength components. A micro controller coupled to the rapid switched narrow line filter receives data and controls the rapid switched narrow line filter to select a plurality of wavelength components in response to the data.

### BACKGROUND OF THE INVENTION

This invention relates to communications systems, in general, and to a method and apparatus for optical wavelength encoded multiplexed arrangements for communications, in particular.

To date, no viable arrangement or method has been provided that will permit the use of optical wavelength encoded communications systems with enough capacity to provide for multiple access. Prior proposed methods and apparatus attempting to provide such systems suffer from significant limitations. In some of the prior proposed arrangements a separate laser must be provided for each wavelength. The result is that either a very few number of wavelengths may be accommodated or the cost of supplying lasers is prohibitive.

### SUMMARY OF THE INVENTION

The present invention provides an economical apparatus and method for providing an optical wavelength encoded multiple access system.

In accordance with the principles of the invention an optical wavelength multiple access system includes a laser source providing multiple wavelength component optical signals. The optical signals are coupled to a rapid switched narrow line filter. The rapid switched narrow line filter is controllable to output selected predetermined wavelength components. A micro controller coupled to the rapid switched narrow line filter receives data and controls the rapid switched narrow line filter to select a plurality of wavelength components in response to the data.

In accordance with on aspect of the invention, a circulator having first, second and third ports, said circulator having a circulator couples the laser to the rapid switched narrow line filter. The rapid switched narrow line filter comprises a 1×N optical switch having a first port and a plurality, N, of second ports. The optical switch is responsive to control signals for establishing optical couplings between the first port and selected ones of the plurality of second ports. Each of the second ports has coupled thereto one or a plurality of wavelength selective reflectors.

Each wavelength selective reflector is selected to reflect optical signals at a predetermined one optical wavelength selected from a plurality of predetermined optical wavelengths. In accordance with one aspect of the invention, each wavelength selective reflectors comprises a reflective filter. In the illustrative embodiment of the invention each reflective filter comprises a fiber Bragg grating.

### BRIEF DESCRIPTION OF THE DRAWING

The invention will be better understood from a reading of the following detailed description taken in conjunction with the several drawing figures in which like reference designations are used to identify like elements in the figures, and in which:

FIG. 1 shows a structure in accordance with the principles of the invention;

FIG. 2 is a second embodiment in accordance with the principles of the invention;

FIG. 3 illustrates a specific structure in accordance with the embodiment of FIG. 2;

FIG. 4 illustrates a portion of the structure of FIG. 3 in greater detail;

FIG. 5 is a top view of a fiber Bragg grating array in accordance with one aspect of the present invention;

FIG. 6 is an end view of the array of FIG. 5; and

FIG. 7 illustrates an alternate embodiment of the structure of FIG. 3.

### DETAILED DESCRIPTION

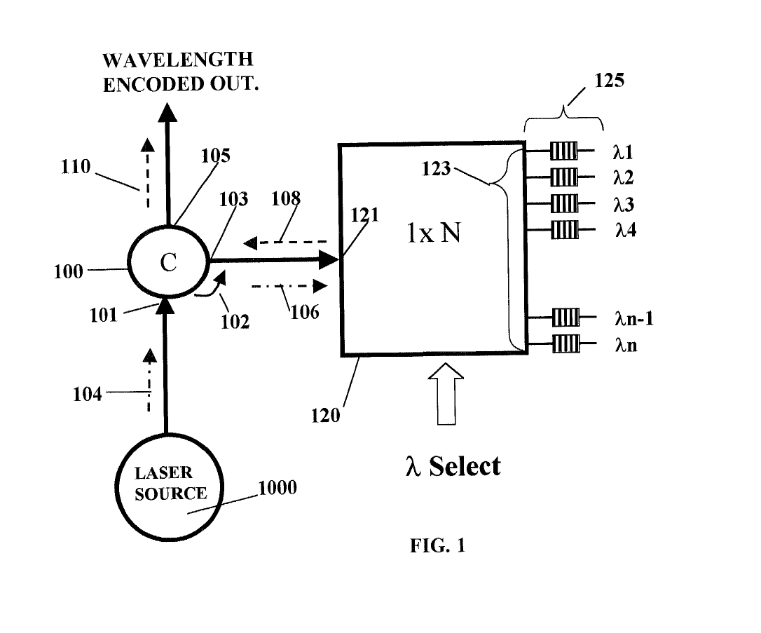

FIG. 1 illustrates a system in accordance with the principles of the invention. The system includes a broadband laser source 1000, a circulator 100 and a rapid switched narrow line filter. Optical signals having wavelength components that are to be utilized in the wavelength encoded multiplex arrangement are supplied by broadband laser 1000. The optical signals from laser 1000 are coupled to an input port 101 of a three port optical circulator 100. Optical circulator 100 has a second port 103 coupled to optical switch 110. A third port 105 serves as an output port. Circulator 100 may be any one of a number of known circulators. An isolator may be inserted into the optical path coupling the source of optical signals to port 101 to make port 101 unidirectional. Similarly. an optical isolator may be inserted into the optical path coupled to port 105 so that optical signals flow unidirectionally out from port 105. Port 103 is a bi-directional port that receives optical signals from port 101 and couples optical signals received at port 103 to port 105. The polarity of circulator 100 is indicated by directional arrow 102. The flow of input optical signals to switch 120 is shown by arrows 104, 106. The flow of wavelength selected optical output signals from optical switch 120 to port 103 and out from port 105 is shown by arrows 108, 110. Optical switch 120 is operable to couple port 121 to any one of a plurality, n, of ports 123. Each of the plurality of ports 123 has coupled thereto a corresponding one of a plurality of reflective wavelength filters 125. Each reflective wavelength filter is a narrow filter and in the illustrative embodiment may be either a fiber Bragg grating or a dielectric interference filter. Both fiber Bragg gratings and dielectric interference filters are known in the art. Each wavelength filter is selected to reflect optical signals that are only at a specific centerline wavelength designated as λ1-λn. The number of filters 125 utilized is dependent upon the specific application and the incremental wavelength difference between adjacent selected wavelengths. Stated another way, the number of filters is determined by the wavelength range over which tuning is to occur and the incremental wavelength, or wavelength granularity between selections. Optical switch 120 receives wavelength selection signals and couples port 121 to selected ones of ports 123 based upon the selection signals. The selected ones of ports 123 is made based upon the desired wavelength components desired. Each of the narrow filters 125 reflects optical signals only at the particular center wavelength of the filter and passes or in effect absorbs all other optical signals. Input optical signals received at circulator 100 port 101 are coupled to port 103 and thereafter coupled to port 121 of switch 120. Switch 120 couples the optical signals to selected ones of filters 125. The selected filters 125 are determined by wavelength select signals received by switch 120.

The selected filters 125 reflect only optical signals at the selected wavelengths back to port 121 and thence to circulator 100 port 103. The selected wavelengths optical signals are coupled out of circulator 100 at port 105. In a first embodiment of the invention, 1×N optical switch 120 is an integrated optic waveguide switch formed on a LiNbO₃ substrate or a substrate of other electro-optic material. This embodiment has the advantages of a high wavelength channel count, fast switch speed and small size.

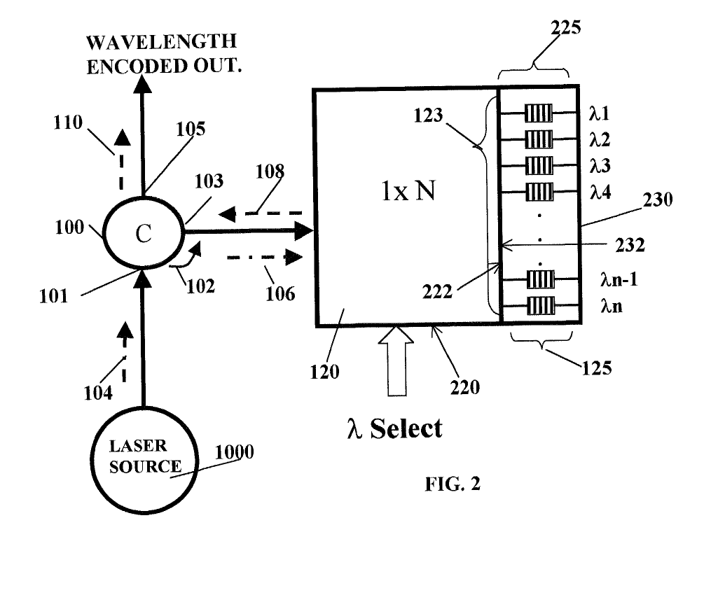

In a second embodiment of the invention shown in FIG. 2, 1×N optical switch 120 is again formed on a LiNbO₃ substrate 220 or a substrate of other electro-optic material. Particular details of the 1×N switch structure are not shown on the structure of FIG. 2, however, in this particularly advantageous embodiment of the invention, the plurality of filters 125 is arranged as a fiber Bragg grating array 225 of filters. A plurality, n, of fiber Bragg gratings 225 are provided on a separate substrate 230 that is affixed to substrate 220. More specifically, a plurality, n, of fiber Bragg gratings 225 are bonded to grooves or channels formed on the surface of a substrate 230. In the specific embodiment shown, substrate 230 is selected to be a silicon substrate. The end surface 232 of substrate 230 that is adjacent to substrate 220 is polished. End surface 232 is bonded to surface 222 of I×N optical switch substrate 220. Bonding of substrate 220 to substrate 230 may be by any one of several known arrangements for bonding substrates together.

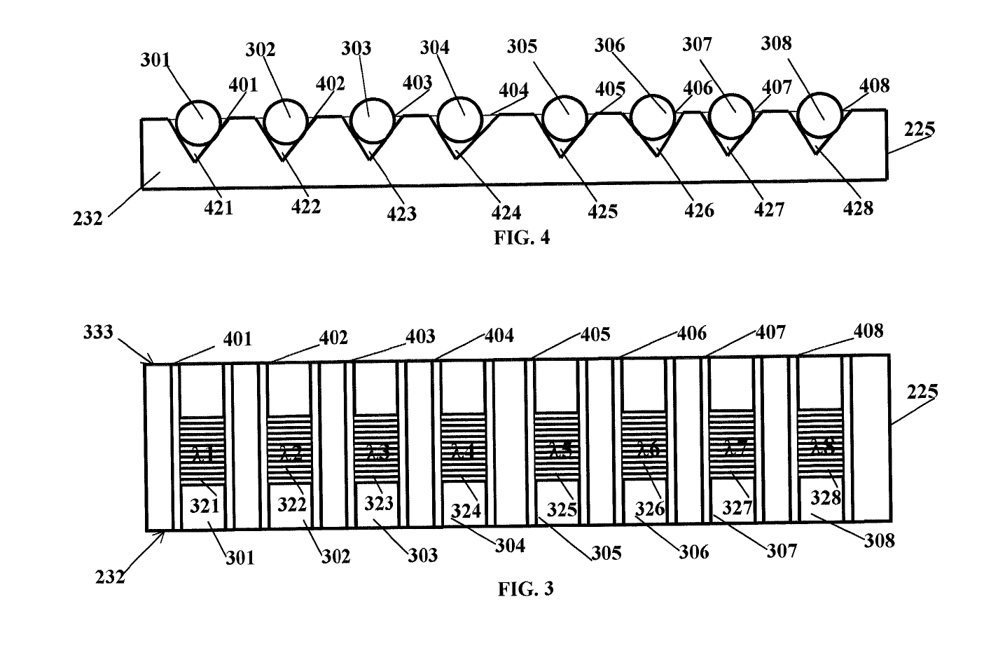

FIGS. 3 and 4 show a fiber Bragg grating array 225 with 8 fiber Bragg grating filters λ1-λ8. Each of the fiber Bragg grating filters λ1-λ8 is a separate fiber segment 301-308 having a Bragg grating 321-328 formed thereon. Each fiber segment is a photosensitive fiber onto which a Bragg grating is formed by using ultraviolet light in conjunction with a different period phase mask for each different filter center wavelength. The forming of Bragg gratings on fibers utilizing such a technique is known in the art. Silicon substrate 230 has a plurality of grooves 401-408 formed on a top surface 412. Each of the grooves 401-408 is shown as a “v” groove, but may be of different cross sectional shape, and rather than being shaped as a “groove” may be a channel. By use of the term “channel”, it will be understood that various cross-sectional grooves is included. In the embodiment shown, the grooves or channels may be formed by use of a saw, or by etching or any other process that will permit controlled depth formation of channels. For example, the v-grooves may be formed by providing an oxide masking layer on the silicon substrate, utilizing a photolithography process to define each of the grooves, and applying an etchant to form the grooves 401-408. After the grooves 401-408 are formed, the fiber segments 301-308 are placed in the grooves 401-408 with fixed spacing and are bonded in position with epoxy. The end surfaces 232, 333 of substrate 230 as well as the corresponding end faces of fiber segments 301-308 are coplanar and polished to optical quality. The corresponding end surface 222 of substrate 220 is likewise polished to optical quality. The fiber Bragg grating array 225 is aligned with the 1×N switch substrate 220 and bonded thereto. The bonding may be with epoxy or any other method of bonding that provides good optical coupling.

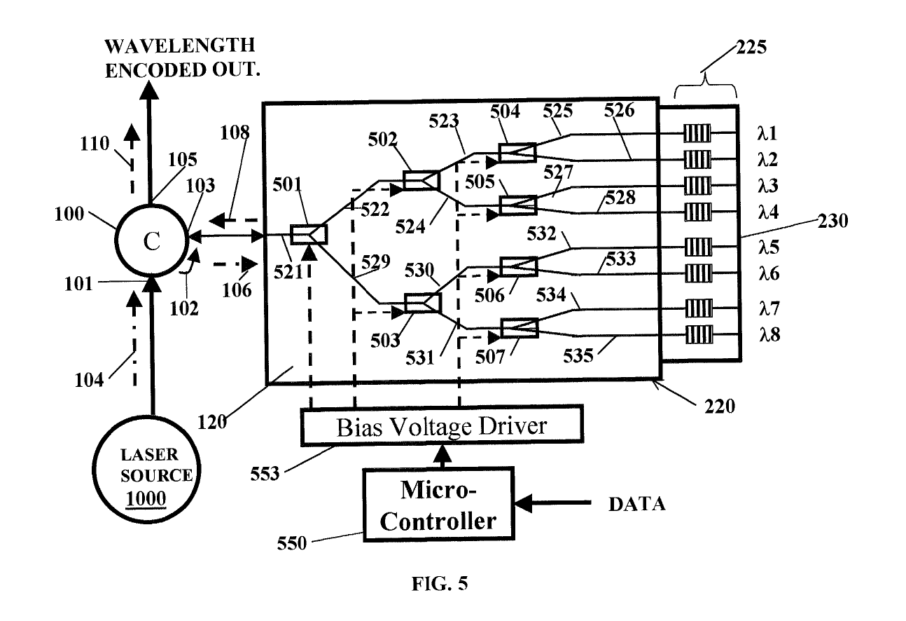

Turning now to FIG. 5, the wavelength encoded multiple access arrangement utilizing a rapid switching narrow line filter of FIG. 2 is shown in greater functional detail. 1×N optical switch 125 is formed from a tree of 1×2 optical switches 501-507 and waveguides 521-535. Switches 501-507 are selectively operated by a microprocessor or micro-controller 550. Micro controller 550 receives data signals that represent the information to be transmitted. Micro controller 550 operates in accordance with algorithms that assign wavelength components to information on a dynamic basis. The particular algorithms that are utilized may be similar ot algorithms that are used in code division multiple access (CDMA) type systems with wavelength components being utilized. Micro controller 550 selects specific wavelength components to provide the wavelength encoding in response to data signals and utilizing additional algorithms determines which optical switches 501-507 to operate to couple optical signals to the corresponding one fiber Bragg grating 125 of array 225.

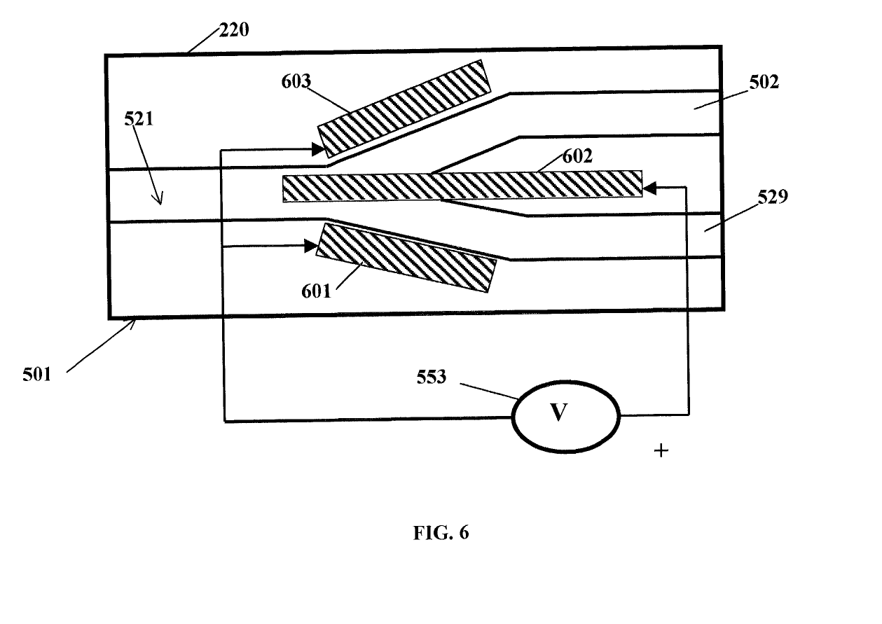

FIG. 6 illustrates a 1×2 switch 501 that is appropriate for use in the 1×N switch arrangement 220 of the invention. Switch 501 is a bi-directional, polarization independent 1×2 switch design. It includes a waveguide that forms a “y” having first, second and third waveguide legs 521, 522, 529. The waveguides 521, 522, 529 are formed on a substrate utilizing known fabrication methods for forming optical waveguides on electro optic substrates such as LiNbO₃. Switch 501 further includes three electrodes 601, 602, 603 that are used to determine the optical path through switch 501. The application of bias voltage V to electrodes 601, 602, 603 determines whether waveguide portion 521 is coupled to waveguide portion 522 or 529. The high voltage switch 501 can switch both TE and TM mode signals. Switch 501 has an on-off ratio of greater than 20 dB. In a reflective design, a double pass produces 40 dB of isolation. With this building block switch structure other sized switches may be provided.

Although switch 501 is shown in detail in FIG. 6, each of the switches 501-507 is of the same construction and all are fabricated on a single substrate 220 in the illustrative embodiment. The waveguides 521-535 are formed utilizing any of the known techniques for formation of waveguides in electro-optic substrates.

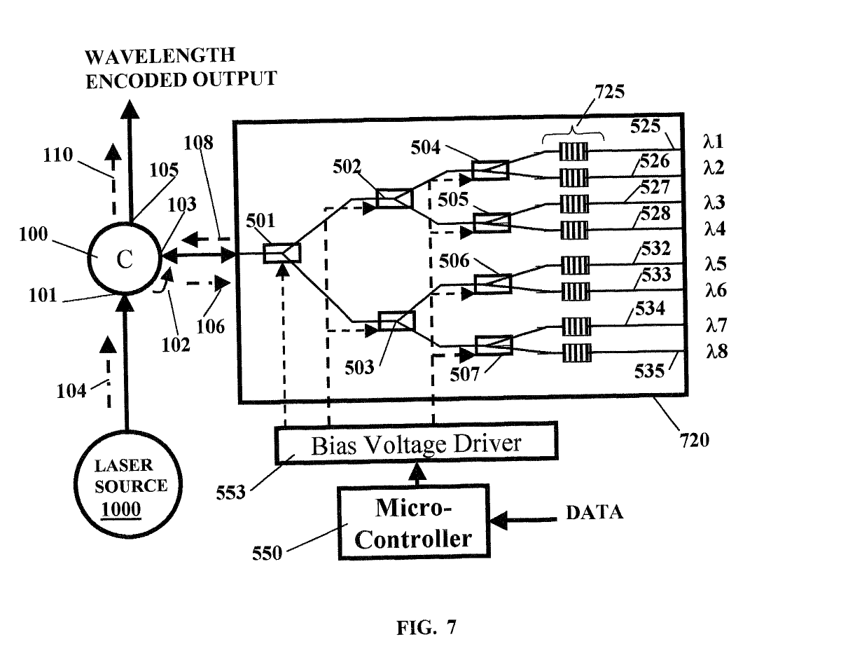

FIG. 7 illustrates another embodiment of the invention in which the reflective filters 525-535 are formed on the same substrate 720 as the 1×N switch. The substrate is LiNbO₃ or another electro optic material. Each filter 725 is formed on a waveguide 525-528, 532-535 formed on substrate 720. Each waveguide has a photosensitive region onto which a Bragg grating is formed. Operation of the structure of FIG. 7 is the same as that of FIG. 5.

In the method of operating the optical apparatus of FIGS. 5 and 7 optical wavelength encoded multiple access signals are generated by providing optical signals having multiple wavelength components from a laser source. The optical signals are coupled to a rapid switched narrow line filter. The rapid switched narrow line filter is controllable to output selected predetermined wavelength components. Data to be wavelength encoded is provided to a micro controller. The micro controller is utilized to control the rapid switched narrow line filter to select a plurality of wavelength components in response to said data. The laser source is coupled to the rapid switched narrow line filter with a circulator having first, second and third ports. The circulator has a circulator directionality going from the first port to the second port and from the second port to the third port. The first port is coupled to the laser, the second port is coupled to the rapid switched narrow line filter, and the third port provides an output for said apparatus.

The operation includes providing as the rapid switched narrow line filter an optical switch having a first port selectively coupleable to a plurality of N second ports and a plurality, N, of wavelength selective filters. Each of said wavelength selective reflectors is coupled to a corresponding one of the optical switch second ports. The wavelength selective reflectors are each selected to reflect optical signals at a predetermined one optical wavelength selected from a plurality of predetermined optical wavelengths.

It should be apparent to those skilled in the art that although the structures shown in the drawing figures illustrate only a 1×8 switch and 8 wavelengths, the number of wavelengths that may be provided in the wavelength encoding and the size of the 1×N switch is a matter of design selection to provide the desired number of selectable wavelengths. For example, 1×16 and 1×32 switches can be built. If it is desired to accommodate a larger number of wavelengths, cascading several stages can accommodate more wavelengths. For example, to accommodate 128 wavelengths, a 1×4 switch can be cascaded with four 1×32 switches.

Various other changes and modifications may be made to the illustrative embodiments of the invention without departing from the spirit or scope of the invention. It is intended that the invention not be limited to the embodiments shown, but that the invention be limited in scope only by the claims appended hereto.

What is claimed is:

1. Optical apparatus, comprising:
a laser source providing multiple wavelength component optical signals;
a rapid switched narrow line filter coupled to said laser source, said rapid switched narrow line filter being operable to receive optical signals from said laser source and being controllable to output selected predetermined wavelength components;
a micro controller coupled to said rapid switched narrow line filter, said micro controller receiving data and controlling said rapid switched narrow line filter to select a plurality of wavelength components in response to said data.

2. Optical apparatus in accordance with claim 1, comprising:
a circulator having first, second and third ports, said circulator having a circulator directionality going from said first port to said second port and from said second port to said third port, said first port coupled to said laser, said second port coupled to said rapid switched narrow line filter, and said third port providing an output for said apparatus.

3. Optical apparatus in accordance with claim 1, wherein:
said rapid switched narrow line filter comprises:
a 1×N optical switch having a first port and a plurality, N, of second ports, said optical switch being responsive to control signals for establishing optical couplings between said first port and a selected ones of said plurality of second ports, said first switch port being coupled to said circulator second port; and
a plurality of wavelength selective reflectors, said wavelength selective reflectors numbering N, each of said wavelength selective reflectors being coupled to a corresponding one of said optical switch second ports, each of said wavelength selective reflectors being selected to reflect optical signals at a predetermined one optical wavelength selected from a plurality of predetermined optical wavelengths.

4. Optical apparatus Optical apparatus in accordance with claim 3, wherein:
first optical signals having components at said plurality of predetermined optical wavelengths are received at said circulator first port and are circulated to said 1×N optical switch via said circulator second port, and
whereby optical signals at a selected wavelength determined by a selected one of said filters are provided to said circulator second port and circulated to said third circulator port.

5. Optical apparatus in accordance with claim 4, comprising:
a first substrate having said 1×N switch formed thereon.

6. Optical apparatus in accordance with claim 5, wherein:
said first substrate comprises an electro-optic material.

7. Optical apparatus in accordance with claim 6, wherein
said substrate comprises LiNbO₃.

8. Optical apparatus in accordance with claim 6 comprising:
a second substrate carrying said plurality of wavelength selective reflectors. Optical apparatus

9. Optical apparatus in accordance with claim 8, wherein:
said second substrate comprises silicon.

10. Optical apparatus in accordance with claim 9, wherein:
said second substrate is bonded to said first substrate.

11. Optical apparatus in accordance with claim 3, wherein:
each of said wavelength selective reflectors comprises a reflective filter.

12. Optical apparatus in accordance with claim 11, wherein:
each of said reflective filters comprises a Bragg grating.

13. Optical apparatus in accordance with claim 11, wherein:
each of said reflective filters comprises a fiber Bragg grating.

14. Optical apparatus, comprising:
a broadband laser;
a circulator having first, second and third ports, said circulator having a circulator directionality going from said first port to said second port and from said second port to said third port, said laser being coupled to said circulator first port;
an optical switch having a first port and a plurality, N, of second ports, said optical switch being responsive to control signals for establishing an optical coupling between said first port and a selected one of said plurality of second ports, said first switch port being coupled to said circulator second port; and
a plurality of wavelength selective reflectors, said wavelength selective reflectors numbering N, each of said wavelength selective reflectors being coupled to a corresponding one of said optical switch second ports, each of said wavelength selective reflectors being selected to reflect optical signals at a predetermined one optical wavelength selected from a plurality of predetermined optical wavelengths,
whereby first optical signals from said laser having components at said plurality of predetermined optical wavelengths are received at said circulator first port and are circulated to said optical switch via said circulator second port, and
whereby optical signals at selected wavelengths determined by selected ones of said filters are provided to said circulator second port and circulated to said third circulator port.

15. Optical apparatus in accordance with claim 14, comprising:
a first substrate having said switch formed thereon.

16. Optical apparatus in accordance with claim 15, wherein:
said first substrate comprises an electro-optic material.

17. Optical apparatus in accordance with claim 16, wherein:
said substrate comprises LiNbO₃.

18. Optical apparatus in accordance with claim 17 comprising:
a second substrate carrying said plurality of wavelength selective reflectors.

19. Optical apparatus in accordance with claim 18, wherein:
said second substrate comprises silicon.

20 Optical apparatus in accordance with claim 19, wherein:
said second substrate is bonded to said first substrate.

21. Optical apparatus in accordance with claim 14, wherein:
each of said wavelength selective reflectors comprises a reflective filter.

22. Optical apparatus in accordance with claim 21, wherein:
each of said reflective filters comprises a Bragg grating.

23. Optical apparatus in accordance with claim 21 , wherein:
each of said reflective filters comprises a fiber Bragg grating.

24. Optical apparatus in accordance with claim 14, wherein:
said optical switch comprises a plurality of first optical switches.

25. Optical apparatus in accordance with claim 24, wherein:
said plurality of first optical switches is arranged as a tree.

26. Optical apparatus in accordance with claim 25, comprising:
a first substrate, said tree of said plurality of first optical switches being formed on said first substrate.

27. Optical apparatus in accordance with claim 24, wherein:
each of said first optical switches comprises a waveguide structure comprising first, second and third legs formed as a “y”, with said second and third legs forming a “v”, and a first electrode proximate said first leg, a second electrode proximate said second leg and a third common electrode.

28. Optical apparatus in accordance with claim 27, comprising:
a substrate of electro optic material having said first switch formed thereon.

29. Optical apparatus in accordance with claim 28, wherein:
said substrate comprises LiNbO₃.

30. Optical apparatus in accordance with claim 14, wherein:
said optical switch is polarization independent.

31. Optical apparatus in accordance with claim 14, wherein:
said optical switch is bi-directional.

32. Optical apparatus in accordance with claim 14, comprising:
a micro controller coupled to said optical switch for controlling operation thereof.

33. A method of generating optical wavelength encoded multiple access signals, comprising:
providing optical signals having multiple wavelength components from a laser source;
coupling said optical signals to a rapid switched narrow line filter, said rapid switched narrow line filter being controllable to output selected predetermined wavelength components;
providing data to be wavelength encoded to a micro controller;
utilizing said micro controller to control said rapid switched narrow line filter to select a plurality of wavelength components in response to said data.

34. A method in accordance with claim 33, comprising:
coupling said laser source to said rapid switched narrow line filter with a circulator having first, second and third ports, said circulator having a circulator directionality going from said first port to said second port and from said second port to said third port, said first port coupled to said laser, said second port coupled to said rapid switched narrow line filter, and said third port providing an output for said apparatus.

35. A method in accordance with claim 33, comprising:
providing as said rapid switched narrow line filter an optical switch having a first port selectively coupleable to plurality of N second ports and a plurality, N, of wavelength selective filters.

36. A method in accordance with claim 35, comprising:
coupling each of said wavelength selective reflectors to a corresponding one of said optical switch second ports

37. A method in accordance with claim 36, comprising:
selecting each of said wavelength selective reflectors to reflect optical signals at a predetermined one optical wavelength selected from a plurality of predetermined optical wavelengths.
